(19) United States
(12) Patent Application Publication
(10) Pub. No.: US 2004/0010066 A1
(43) Pub. Date: Jan. 15, 2004

(54) Flame retardant dispersible powders on a wax, polymer, or organic carrier

(76) Inventor: Stephen J Devine, Tyne ?amp; Wear (GB)

Correspondence Address: Thomas A Ladd, Baker & Daniels, Suite 2700, 300 North Meridian Street, Indianapolis, IN, 46204, US

(21) Appl. No.: 10/312,218

(22) PCT Filed: Jun. 28, 2001
(86) PCT No.: PCT/US01/20519

(30) Foreign Application Priority Data
Jun. 30, 2000 (GB) 0015908.7

(51) Int. Cl. C08K 3/10; C08K 9/02; C09K 21/00

(52) U.S. Cl. 524/409; 252/601; 523/204

(57) ABSTRACT

The present invention is directed to the formation of a solid, dispersible flame retardant powder, by depositing solid flame retardant particles, via electrostatic and packing interactions, onto emulsified droplets of a melted wax, melted polymer, or organic solid carrier, or onto droplets of an organic liquid carrier. Additionally, the invention is directed to the use of such particles as flame retardants in a thermoplastic or the thermosetting polymer composition and coatings.

### FIELD OF THE INVENTION

The present invention is directed to the formation of a solid, dispersible flame retardant and/or smoke suppressant powder, by depositing solid flame retardant particles, via electrostatic and packing interactions, onto emulsified droplets of a melted wax, melted polymer, or organic solid carrier, or onto droplets of an organic liquid carrier. The invention also is directed to the use of such particles as flame retardants in a thermoplastic or thermosetting polymer composition. Additionally, the invention is directed to the use of such particles as flame retardants in thermoplastic or thermosetting polymer compositions and as coatings, such as textile backing coatings.

### BACKGROUND OF THE INVENTION

The ability of various solids to act as flame retardants is well known to those skilled in the art. Examples of such flame retardant solids include hydrated salts, organic phosphates, metal borates, polyamides, solid halogenated flame retardants with a melting point greater than 100° C., molybdenum compounds, ferrocenes, antimony compounds, zinc compounds, and bismuth compounds. Such solids impart flame retardant properties by various mechanisms, including the following:

a) Release of Water and/or Carbon Dioxide: Hydrated salts (e.g., magnesium sulfate pentahydrate, aluminum trihydrate, magnesium hydroxide, and the like) decompose at high temperatures to endothermically release water and/or carbon dioxide to quench a fire.

b) Char Formation: When exposed to fire and/or high temperatures, char formers (e.g., organic phosphates, zinc compounds, nitrogen compounds, silicon compounds, and metal borates) form char barriers which insulate the combustible material from the fire, preventing the material from reaching combustion temperature.

c) Free Radical/Oxygen Deprivation: Halogen compounds, alone or in combination with antimony, will prevent combustion. The primary mechanism is believed to be the formation of a dense gas layer which inhibits oxygen from reaching the flame, thereby quenching the fire. There is also evidence that halide compounds, alone or in combination with antimony, may scavenge free radicals in the flame, thereby stopping the combustion reaction.

All of the above listed flame retardant solids are used commercially to provide flame retardation in a variety of commercial materials, such as plastics, carpets, fabrics, paints, coatings, adhesives, and the like. Unfortunately, the use of such solids in a flame-retarding effective amount is often limited, due to the imparting of other undesirable properties to the materials by the solid flame retardant at a relatively low loading level. Such properties include a loss of flexibility, loss of impact strength, addition of unwanted coloration, and loss of light transmission.

In thermoplastic polymer compositions, a combination of antimony trioxide, such as Laurel Fire Shield H (Oxy Corp.) or Timonox Red Star (Great Lakes Sales (UK) Ltd.), and a halide (e.g., octabromodiphenyl-oxide, decabromodiphenyloxide, ethylene bis-tetrabromophthalimide, or decabromodiphenylethane) is the preferred commercial combination for imparting flame retardant properties to the polymer. Unfortunately, such antimony trioxide/halide combinations can cause the thermoplastic polymer compositions to suffer from one or more of the undesirable properties described above. In addition, if the particle size of the flame retardant solid is large relative to the particle size of the polymer composition, inadequate heterogeneous mixing of the flame retardant and the polymer and/or aggregation of flame retardant particles in the polymer may occur, causing a further reduction in the flame retardancy, flexibility, and strength of the finished polymer articles.

It is well known in the art that many of the undesirable properties described above can be substantially reduced or eliminated by ensuring that the particle size of the flame retardant solid used is below 0.1 micron. Such particle sizes can be achieved through wet media milling of the flame retardant, using water, an organic liquid, or a meltable solid dispersion. For example, U.S. Pat. No. 5,948,323 issued to McLaughlin et al., and hereby incorporated by reference, describe stable dispersions of wet media milled colloidal flame retardant solid particles, having a size of about 1 to 1,000 nanometers, with an average size from 1 - 100 nanometers, in fluids such as water, organic liquids, or meltable solids, and methods of making them. However, the high fluid content of such wet media milled dispersions (e.g, 40-95% by weight fluid vehicle and 5-60% by weight solids), can limit the use of such dispersions as flame retardants in solid thermoplastic polymer compositions, as well as other solids. The high fluid levels present can result in defects, such as the trapping of liquid or gas particles in the thermoplastic polymer composition during processing, or inadequate dispersion of the flame retardant within the thermoplastic polymer composition due to fluid which remains associated with the flame retardant particles.

While such fluid dispersions can be dried directly using various methods known to those skilled in the art, such techniques remain limited by the tendency of the flame retardant, upon drying, to associate in hard agglomerates or clumps of material. Such agglomerates are believed to be stabilized by capillary pressure between solid particles around the exterior of individual solid particles of flame retardant, even after drying. Upon addition to and processing with the thermoplastic polymer composition, these hard agglomerates cannot be re-dispersed into individual particles. Further, such agglomerates may inhibit the activity of the flame retardant in the thermoplastic polymer composition by decreasing the active flame retardant surface area available, and can interfere with physical and aesthetic properties, such as flexural and impact strength, of the final polymer composition.

Thus, there remains a need in the art for a solid, stable dispersion which imparts acceptable levels of fire retardation to a thermoplastic polymer-containing composition, while simultaneously retaining the strength properties of the thermoplastic polymer, such as impact resistance, and maintaining flexural properties.

### SUMMARY OF THE INVENTION

In brief, the present invention is directed to the formation of a solid, dispersible flame retardant powder, by transferring a solid flame retardant, via electrostatic and packing interactions, from an emulsion to a wax, polymer, organic liquid or organic solid carrier. Additionally, the invention is directed to the use of such particles as flame retardants in a polymer composition.

A further aspect of the invention to provide a solid, dispersible powder, suitable for use as a flame retardant in a polymer-containing composition, which minimizes the loss of mechanical strength and flexibility of the thermoplastic polymer-containing composition, while maintaining acceptable levels of fire retardant properties.

Another aspect of the invention is to provide a solid flame retardant associated with an organic liquid carrier suitable for use as a flame retardant in a polymer-containing composition, which minimizes the formation of defects in the polymer composition while imparting acceptable levels of flame retardant properties to the polymer.

Another aspect of the invention is to provide a process for the formation of a solid, dispersible flame retardant product comprising a wax, polymer, organic liquid or organic solid central core, acting as a carrier, and containing one or more covering layers of a flame retardant, comprising: 1) addition of a wax, polymer, organic liquid or organic solid to a fluid carrier/surfactant solution with sufficient mixing, and heat if necessary, to form an emulsion; 2) deposition of a solid flame retardant powder on the surface of the wax, polymer, organic liquid or organic solid to form a particle containing small emulsified particles of wax, polymer, organic liquid or organic solid surrounded by one or more covering layers of a solid, flame retardant powder in a fluid carrier; 3) settling of the wax, polymer, organic liquid or organic solid core material covered with the solid, flame retardant powder in the fluid carrier; and 4) removal of the fluid, leaving a flame retardant consisting of a wax, polymer, organic liquid or organic solid central core acting as a carrier, and containing one or more covering layers of a flame retardant.

Thus, according to one embodiment of the present invention, a wax, polymer, organic liquid or organic solid is added to a first fluid carrier, preferably water, along with a first surfactant, and the combination of first surfactant, fluid carrier, and wax, polymer, organic liquid or organic solid is mechanically agitated to form the emulsion. Preferably, the first fluid carrier is heated. Further, if a wax, polymer, or organic solid is used, the wax, polymer, or organic solid preferably has a sufficiently low melting temperature such that, upon addition to the heated first fluid carrier, the wax or polymer melts. If the wax, polymer, or organic solid has been chosen such that it will not melt in the heated first fluid carrier, then preferably the wax, polymer, or organic solid has been previously processed to a particle size of less than one hundred microns. Such processing (e.g., emulsification of the core material and/or milling) are well known to those skilled in the art. Preferably, the wax, polymer, or organic solid has been previously processed to a particle size of less than fifty microns. In accordance with the preferred embodiment, the wax used is a hydrogenated castor oil. The dispersible powder product includes about 1% by weight to about 50% by weight core material, preferably about 2% to about 20% core material, based on the dry weight of the flame retardant particles surrounding the core material.

The particular first surfactant used to form the emulsion between the wax, polymer, organic liquid or organic solid and the first fluid carrier is not critical and can be any surfactant possessing a charge separation (e.g., a dipole moment or an ionic charge) greater than that of water (1.76 D) and capable of forming an emulsion, via agitation, between the wax, polymer, organic liquid or organic solid core material, and the first fluid carrier. In accordance with the preferred embodiment, the first surfactant used is a pyridine salt, preferably hexadecylpyridinium chloride monohydrate.

Other examples of useful pyridinium salts include: dodecylpyridinium bromide; dodecylpyridinium chloride; dodecylpyridinium iodide; butadecylpyridinium bromide; butadecylpyridinium chloride; hexadecylpyridinium bromide; hexadecylpyridinium chloride; octadecylpyridinium bromide; and octadecylpyridinium chloride. The preferred pyridinium salts are halogenated pyridinium salts, having a carbon chain length of C₁₂ to C₁₈, and will function as emulsifiers. The micelle concentration of the compounds decreases with an increase in carbon chain length and also decreases with increasing atomic number of the halogen ion used (hence the limited use of the iodide ion salts).

The first surfactant lowers the surface tension at the interface between the wax, polymer, organic liquid or organic solid and the first fluid carrier, allowing the particle size of the wax, polymer, or organic liquid core material droplets to be minimized. In addition, the first surfactant acts as an emulsifier, reducing the coalescence of wax, polymer, organic liquid or organic solid particles in the first fluid carrier and increasing the stability of small wax, polymer, organic liquid or organic solid particles. Further, the first surfactant, via electrostatic (e.g., ion-dipole or dipole-dipole) interactions, generates an electrostatic charge at the surface of the wax, polymer, organic liquid or organic solid core material.

A flame retardant or flame retardant composition is then added to the agitating emulsion. Such flame retardant or flame retardant compositions include one or more flame retardants preferably selected from the group consisting of antimony trioxide, antimony pentoxide, decabromodiphenyloxide, hexabromo-cyclododecane, melamine phosphate, melamine pyrophosphate, ammonium polyphosphate, resorcinol diphosphate, diammonium phosphate, antimony metal, sodium antimonate, mixed metal oxides of zinc and magnesium, zinc sulfide, bismuth subcarbonate, zinc borate, barium metaborate, molybdenum oxide, ammonium octamolybdate, ferrocene, magnesium hydroxide, bis-tribromophenoxy ethane, tetrabromobisphenol A, zinc stannate, malamine cyanurate, ethylene bis-tetrabromophthalimide, aluminum trihydrate and mixtures of any two or more of the foregoing. Preferably, the flame retardant composition is antimony trioxide in water and/or an organic liquid carrier, where the antimony trioxide has been combined with a second surfactant and then milled to a particle size of less than 0.1 micron. Such milling methods (e.g., wet agitated media milling) are well known to those skilled in the art. To achieve the full advantage of the present invention, the second surfactant possesses a charge separation (e.g., a dipole or an ionic charge). Such compounds with a charge separation include anionic, cationic, or amphoteric surfactants. Specifically, such surfactants include lignosulfates, phosphate esters, sulfated alcohol ethoxylates, alkylbenzenesulfonates, sulfonate esters, naphthalene sulfonates, α-olefinsulfonates, sodium silicates, N-acrylsarcosinates, polyacrylates, polycarboxylic acid salts, polymaleic anhydride/polyethylene glycol (PMA/PEG) blends, long-chain amines, amine oxides, amine ethoxylates, quaternary ammonium salts, alkyl betaines, and imidazolines, and blends thereof. In accordance with the most preferred embodiment, the second surfactant is Borresperse Na (LignoTech USA, Inc.), a sodium lignosulfate with a measurable dipole moment. The second surfactant acts as a dispersant, dispersing the antimony trioxide evenly throughout the second fluid carrier and reducing the tendency of flame retardant particles to associate into hard agglomerates. Further, the second surfactant acts to generate a charge at the surface of the flame retardant.

The flame retardant is then deposited on the surface of the wax, polymer, organic liquid or organic solid core material through a series of electrostatic (dipole-dipole or ion-dipole) interactions. The resultant particles, or “prills”, which are composed of a central core of wax, polymer, organic liquid, or organic solid, surrounded by one or more, preferably multiple, layers of loosely packed flame retardant solid particles, rapidly settle out of solution. The fluid can then be decanted away or otherwise separated from the particles, and the particles dried using any drying method known to those skilled in the art.

The advantages of such a formation of a solid, dispersible flame-retardant powder are manifest. For example, by transferring the active flame retardant from the liquid phase to the solid phase, the flame retardant may be easily dispersed throughout the polymer-containing composition, while maintaining flexibility, mechanical strength and currently acceptable flame-testing criteria, such as the LOI (limiting oxygen index) and UL-94 (Underwriters Laboratories) standards. Dispersions of such particles are also convenient, since they allow the flame retardant to be easily transported.

Solid dispersions also minimize the level of waste flame retardant, and ease recycling of material unattached to the wax, polymer, organic liquid or organic solid core material. Typically, an excess of flame retardant will be used in the system. By maintaining the flame retardant in an emulsion, upon decantation any excess flame retardant particles can be easily recycled by separation of the second fluid carrier and surfactant from the first fluid carrier, followed by addition of a further amount of wax, polymer, organic liquid or organic solid in the first fluid carrier.

In addition, solid dispersions simultaneously inhibit flocculation of the flame retardant into larger than 2 micron particles. These flocs, which are formed from individual flame retardant particles which associate via hydrophobic interactions and capillary pressure, have a particle size larger than 2 microns, and are unattached to the wax, polymer, organic liquid or organic solid core material. Upon decantation of the fluid carrier and drying, these flocs dry as hard particles of flame retardant which can fail to redisperse upon addition to a thermoplastic polymer melt, generating flaws in the thermoplastic polymer. The 2 micron agglomerates present in the solid dispersions of the present invention, are held together by electrostatic forces weaker than those which maintain the structural integrity of a particle unattached to the wax, polymer, organic liquid or organic solid. While sufficient to maintain the structural integrity of the agglomerate under normal handling conditions, upon addition to a polymer containing composition, these agglomerates collapse, and redisperse to the individual primary particle size (e.g., less than 1 micron). Preferably, the individual primary particle size is below 0.5 micron. Most preferably, the individual primary particle size, e.g., less than about 1 micron, preferably less than about 0.5 micron, more preferably less than about 0.1 micron.

### BRIEF DESCRIPTION OF THE DRAWINGS

The present invention may be best understood by reference to the following detailed description of a preferred embodiment, when considered in conjunction with the following drawings. The drawings are intended to represent one possible mechanism of formation for the final prill structure, and should not be construed as a limitation on the process by which the solid, dispersible flame retardant powder is obtained. Thus,

FIG. 1 is a diagram of a micelle formed by the interaction of a wax, polymer, or organic liquid and a first surfactant;

FIG. 2 is a diagram of a micelle formed by the interaction of a powdered, solid flame retardant material and a second surfactant;

FIGS. 3A and 3B are diagrams of one mechanism for the deposition of the initial layers of flame retardant onto the wax, polymer, or organic liquid core material;

FIGS. 4A and 4B are diagrams of one mechanism for the formation of 2 micron agglomerates from individual particles of flame retardant;

FIGS. 5A and 5B are diagrams of one mechanism for the deposition of the outer layers of flame retardant on the prill structure; and

FIG. 6 is a diagram of the structure of the dispersible powder formed by the process of the invention;

FIG. 7 is a transmission electron photomicrograph detailing the outer structure of a dispersible powder formed by the process of the invention;

FIG. 8 is a transmission electron photomicrograph showing the dendritic structure of the outer layers of flame retardant in a dispersible powder formed by the process of the invention;

FIG. 9 is a transmission electron photomicrograph detailing microscopic dispersion in a acrylonitrile-butadiene-styrene (ABS) containing composition compounded with 5% by weight of a dispersible powder formed by the process of the invention;

FIG. 10 is a transmission electron photomicrograph detailing microscopic dispersion in a acrylonitrile-butadiene-styrene (ABS) containing composition compounded with 4% by weight MICROFINE® AO5 antimony trioxide (Great Lakes Chemical Corp.) commercial flame retardant (hereinafter “AO5”);

FIG. 11 is a transmission electron photomicrograph detailing microscopic dispersion in a acrylonitrile-butadiene-styrene (ABS) containing composition compounded with 4% by weight of the commercial flame retardant Timonox Red Star (Great Lakes Sales (UK) Ltd.);

FIG. 12 is a graph of peak force measurements obtained in an impact resistance test, using an ABS containing composition compounded with varying percentages by weight of a dispersible powder formed by the process of the invention;

FIG. 13 is a graph of peak energy measurements obtained in an impact resistance test, using an ABS-containing composition compounded with varying percentages by weight of a dispersible powder formed by the process of the invention;

FIG. 14 is a graph of flexural modulus measurements obtained in a three-point bend flexural test, using an ABS-containing composition compounded with varying percentages by weight of several antimony trioxide-based flame retardants;

FIG. 15 is a graph of flexural strength measurements obtained in a three-point bend flexural test, using an ABS-containing composition compounded with varying percentages by weight of several antimony trioxide-based flame retardants.

FIG. 16 is a graph of fail energy of decabromodiphenyloxide (DBDPO) on castor wax particles, in comparison to other flame retardants;

FIG. 17 is a graph of fail energy of antimony trioxide on castor wax particles (Dispersible Powder AT), made in accordance with Example 1, using hexadecylpyridinium bromide instead of hexadecyclpyridinium chloride, in comparison to prior art antimony trioxide (hereinafter “AT”) particles, showing that the products are essentially identical using either emulsifier;

FIG. 18 is a graph showing some mechanical properties of a nylon polymer containing the dispersible powdered AT on an amide wax core, compared to TxRs (Timonox Red Star) antimony trioxide (hereinafter “Red Star”); and

FIG. 19 is a graph showing some mechanical properties of polypropylene fiber containing the dispersible powdered AT on an ester wax core, alone and with a brominated graft copolymer in comparison to the copolymer with and without a typical AT.

### DETAILED DESCRIPTION OF THE PREFERRED EMBODIMENTS

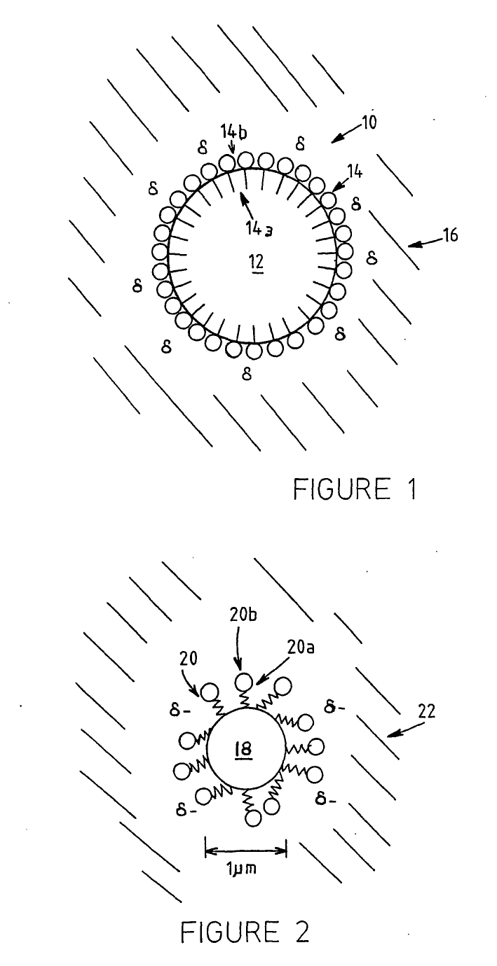

Referring to FIG. 1, each individual prill structure 10 contains a wax, polymer, organic liquid, or organic solid core material 12, which upon interaction with first surfactant 14 in a fluid carrier 16 (e.g., water), forms a stable micellar structure in which the hydrophobic portion 14a of the first surfactant 14 is either inserted into or is closely associated with the outer surface of the surface of the wax, polymer, or organic liquid core material 12, while the charged, hydrophilic portion 14b of the first surfactant 14 interacts with the fluid carrier 16. This results in the wax, polymer, organic liquid or organic solid core/surfactant micelle having a net charge δ at its surface. Similarly, as shown in FIG. 2, the flame retardant particles 18, upon interaction with the second surfactant 20 in a second fluid carrier 22, forms a separate, stable micellar structure in which the hydrophobic portion 20a of the second surfactant is closely associated with the surface of the flame retardant particle 18, while the hydrophilic portion 20b interacts with the fluid carrier 22. The second surfactant-flame retardant micelle has a net charge δ at the micelle surface, which is opposite to the charge δ presented by the first surfactant 14 at the surface of its micelle.

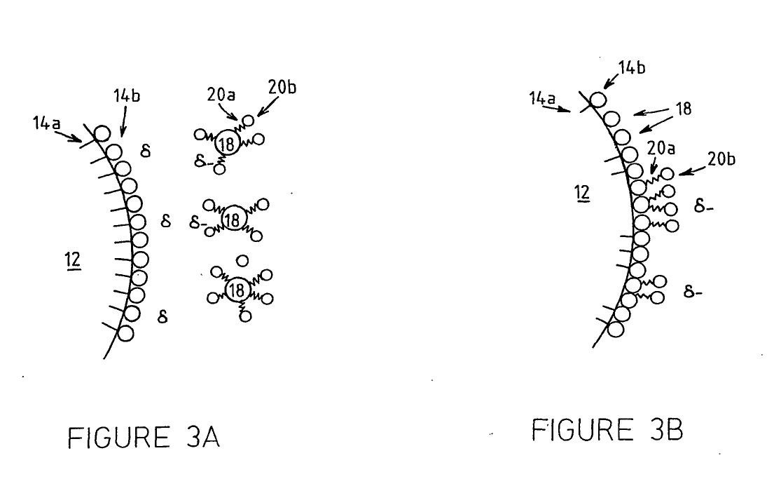

The flame retardant particles 18 are believed to be deposited onto the wax, polymer, organic liquid or organic solid core material 12 in two stages. Referring to FIG. 3B, the initial layers of flame retardant are comprised of individual flame retardant particles 18 approximately 0.1 micron or smaller in diameter. As shown in FIG. 3A, these particles 18 are deposited on the surface of the wax, polymer, organic liquid or organic solid core material 12 via charged particle electrostatic attraction between micelles containing the charged wax, polymer, organic liquid or organic solid carrier core material 12 and micelles containing the individual particles of flame retardant 18. Upon interaction, the flame retardant 18 tends to adhere to the wax, polymer, organic liquid or organic solid core material 12 due to both charged particle attraction and a preference for interaction with other particles of flame retardant 18 as opposed to first fluid carrier 16 and second fluid carrier 22. This results in the deposition of several layers of flame retardant particles 18 on the surface of the wax, polymer, organic liquid or organic solid core material 12, to an approximate thickness of 300-500 nm.

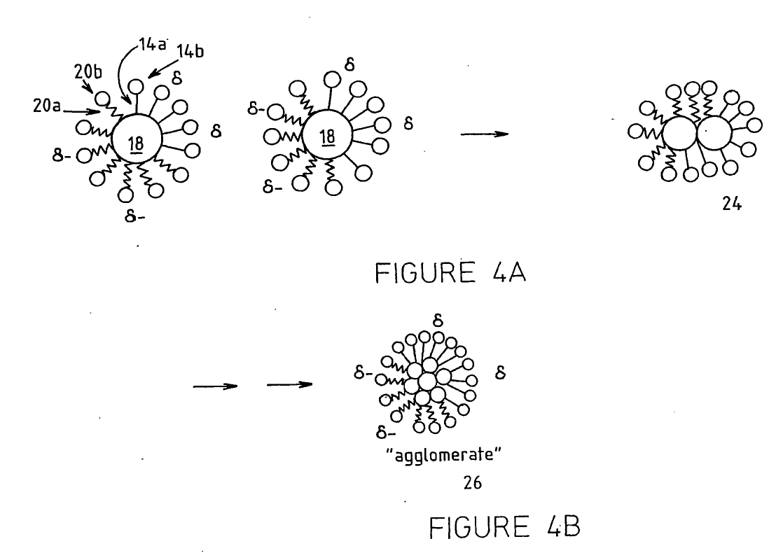

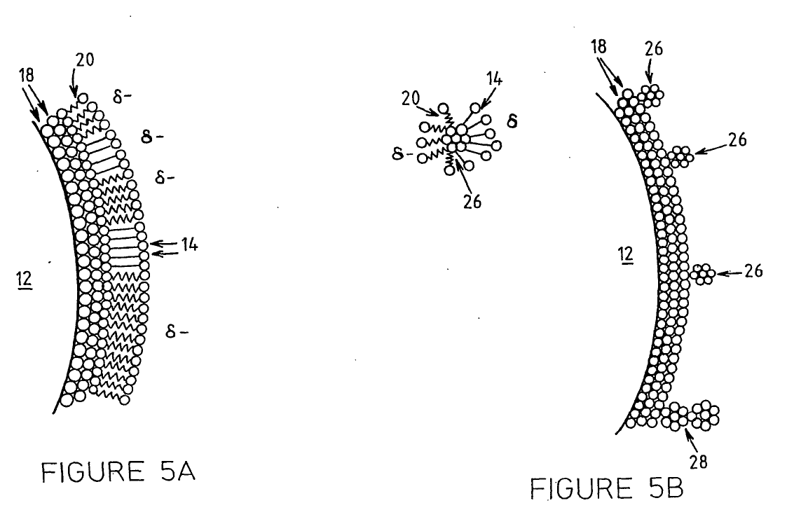

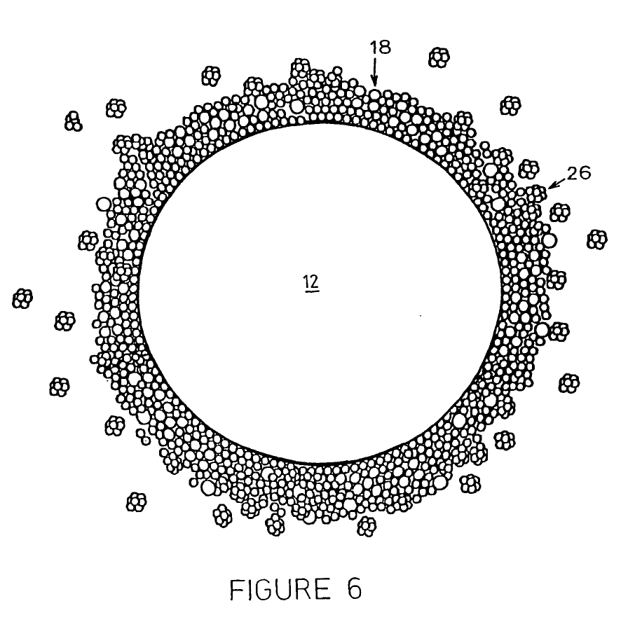

The outer layers of flame retardant particles 18 are believed to be a combination of individual primary particles 18, having a particle size of approximately 1 micron or smaller in diameter, and agglomerates of flame retardant particles 26 up to 2 microns in diameter, as shown in FIG. 6. Preferably, the size of the individual primary particles 18 is below 0.5 micron, more preferably, less than 0.1 micron in diameter. Referring to FIG. 4A, these agglomerates 26 are formed by the interaction of flame retardant particles 18, first surfactant 14, and second surfactant 20 in fluid carriers 16 and 22. Because the amount of second surfactant 20 is insufficient to occupy all available sites on the flame retardant particles 18, first surfactant 14 occupies several sites on the surface of a number of flame retardant particles 18. This results in a number of individual flame retardant particles 18 exhibiting opposing charges on opposite sides of the particle, generating a dipole moment. These bipolar flame retardant particles 24, through electrostatic interactions with each other, form bipolar agglomerates 26, as shown in FIG. 4B. Referring to FIG. 5A, these agglomerates 26 seed the deposition of the outer layers of flame retardant particles 18 via electrostatic interactions with flame retardant particles 18 previously deposited onto the wax, polymer, organic liquid or organic solid core material 12. In the final layers of flame retardant particles 18, seeding of subsequent layers of flame retardant 18 by agglomerates 26 often takes the form of long, dendritic clusters 28, as shown in FIG. 5B. These dendritic clusters 28 are composed of agglomerates 26 and individual flame retardant particles 18. Such clusters 28 can reach a length of several microns, e.g., 2-10 microns.

After separation from the fluid carriers 16 and 22 and drying, each individual prill structure 10 is a spherical particle approximately 1-20 microns in size. A small amount of first fluid carrier 16 and second fluid carrier 22, typically 1-3% total by weight, remains associated with the prill 10. Referring to FIG. 6, the theoretical structure of the resultant prill 10 is a wax, polymer, organic liquid or organic solid central core 12 surrounded by inner layers of individual flame retardant particles 18 and outer layers comprised of both individual flame retardant particles 18 and agglomerates 26, which are comprised of flame retardant particles 18. The flame retardant particles 18 comprising the exterior of the prill 10 is kept in close association with the wax, polymer, organic liquid or organic solid central core 12 through both electrostatic interactions between the wax, polymer, organic liquid or organic solid core material 12 and flame retardant particles 18, and electrostatic interactions between individual flame retardant particles 18 and agglomerates 26. Upon addition to a thermoplastic polymer composition and compounding, these electrostatic attractions are insufficient to maintain the structural integrity of the prill 10, causing both the flame retardant particles 18 and the agglomerates 26 to re-disperse, as individual flame retardant particles 18, to their initial primary particle size of about 1 micron or less, preferably less than 0.5 micron, more preferably less than about 0.1 micron.

It will be apparent to those skilled in the art that the wax, polymer, organic liquid or organic solid core material 12 should be chemically compatible with the polymer composition into which the flame retardant will be incorporated. Similarly, the fluid carrier 16 used for the wax, polymer, organic liquid or organic solid core material 12 should be chemically compatible with the fluid carrier 22 used for the flame retardant particles 18 (e.g., two aqueous carriers). While substantially all flame retardant particles 18 present in fluid carrier 22 can be adsorbed onto the wax, polymer, organic liquid or organic solid substrate 12, when the weight ratio of wax, polymer, organic liquid or organic solid core material 12 to flame retardant particles 18 is low, the thickness of the flame retardant layer electrostatically adhered to the wax, polymer, organic liquid or organic solid core material 12 tends to increase. Simultaneously, the packing density of the outer layers of flame retardant particles 18 and agglomerates 26 in the prill 10 tends to decrease. With additional buildup of subsequent layers of flame retardant particles 18, as the radius of the flame retardant layers, measured outwardly from the outer surface of the core material 12, begins to surpass the radius of the central core 12, these less dense layers become vulnerable to separation from the central core material 12. For example, in the preferred embodiment, where the radius of the central core material 12 is approximately 20 microns, layers of flame retardant particles 18 become vulnerable to separation when their exceeds 20 microns, for a total particle size of 80 microns. These separated layers are subsequently dried as hard, unattached flocs of flame retardant particles 18. Such hard flocs will not re-disperse upon addition to a polymer composition and subsequent compounding, which can lead to flaws in the polymer matrix.

### EXAMPLES

The following examples are illustrative of various preferred embodiments of the above described invention. Further examples should be readily apparent to those skilled in the art.

### Example 1

### Antimony Trioxide (AT) on a Castor Wax Core

Hexadecylpyridinium chloride monohydrate was added to water at a temperature of greater than 87° C. at a concentration of approximately 5×10⁻³ M/L. To this solution, castor wax was added, either in powdered or flake form. Mechanical agitation was started as the wax began to melt in solution, forming an emulsion. Once the wax had completely melted, antimony trioxide slurry, previously fluid-milled to a particle size less than 0.1 micron, (Azub™/AT-40 hereinafter “AT-40”), Great Lakes Chemical Corp.) was added to the agitating emulsion. The resultant prills immediately began to form and settled out of solution once mechanical agitation was stopped or slowed. The resultant liquor was removed by decantation, and the prills dried using an atomizing wheel spray dryer. The resultant prill structure, when dried, typically has a particle size of 1-20 microns, with a continuous active antimony trioxide coating layer, typically 1-10 microns in thickness.

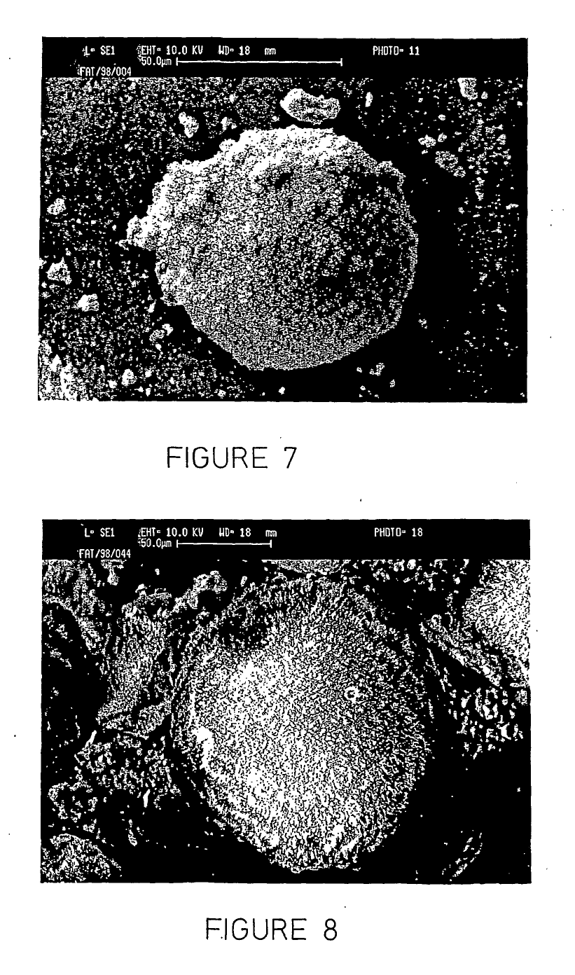

The product manufactured is a free flowing powder. Transmission electron microscopy shows the structure of the flame retardant particles is that of a central wax core with multiple layers of antimony trioxide loosely packed around the center, as shown in FIG. 7. While in powder form, individual flame retardant particles tend to associate in dendritic clusters at the surface of the prill, as shown in FIG. 8. Adsorption isotherms have shown that substantially all of the antimony trioxide is adsorbed onto the surface of the wax substrate.

### Example 2

### AT on a Castor Wax Core (Example 1) in Acrylonitrile-Butadiene-Styrene (ABS)

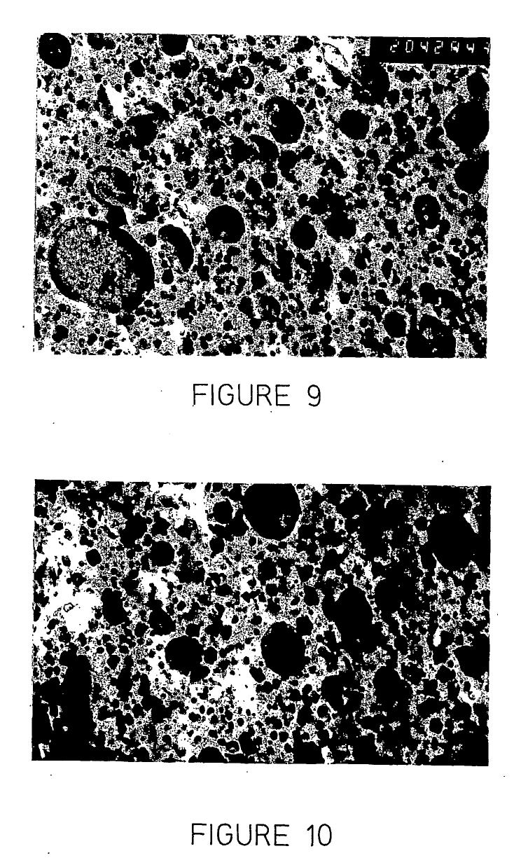

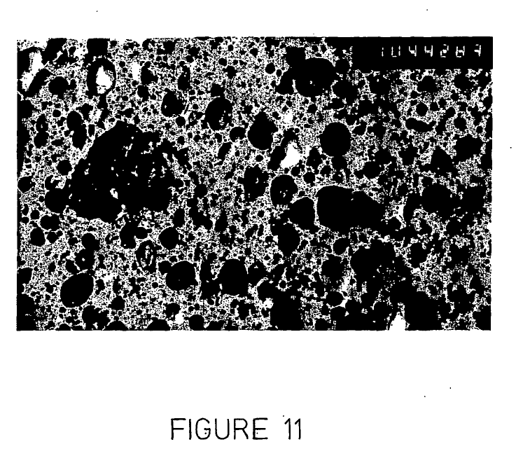

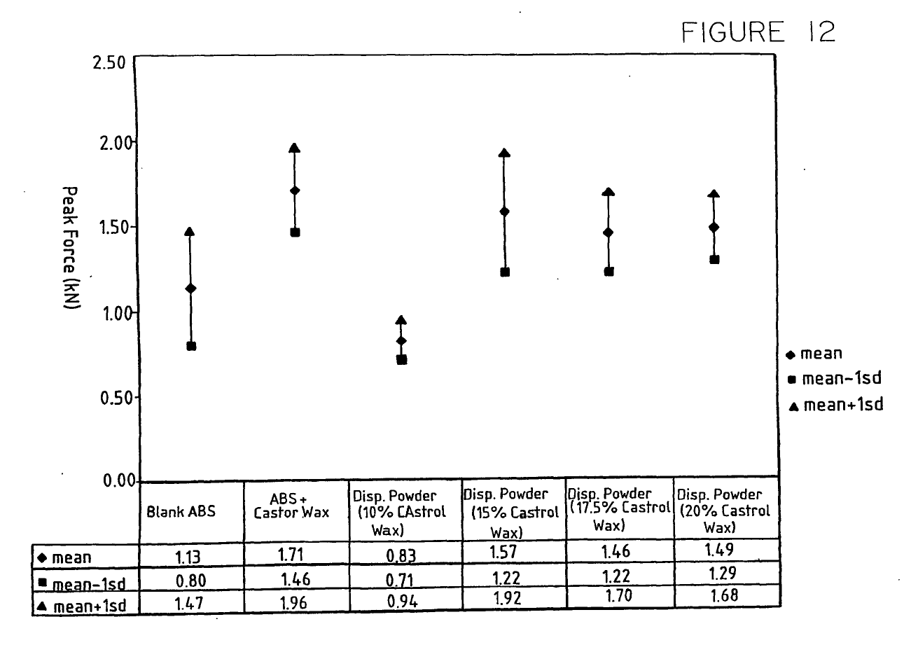

Transmission electron microscope studies were used to study the dispersion characteristics of the powder, manufactured in accordance with Example 1, in an acrylonitrile-butadiene-styrene (ABS) polymer-containing composition (Cycolac™, General Electric Corp.). The electron micrograph showed the powder had superior dispersion characteristics compared to several standards. While the micrograph does show limited agglomeration of antimony trioxide particles (see FIG. 9), the majority of the material, upon addition to the ABS composition, redispersed back to an individual particle size of less than 0.1 micron, which is smaller than the smallest polybutadiene particles naturally present in the ABS polymer-containing composition (0.2 μm). In contrast, as shown in FIGS. 10-11, both Red Star and AO5, two commercially available flame-retardant antimony trioxide formulations, had poor dispersion capabilities, with a number of antimony trioxide particles which are larger than the smallest polybutadiene particles naturally present in the ABS polymer-containing composition, generating flaws in the ABS polymer-containing composition.

### Example 3

### Processing of AT (Example 1) in ABS

The flame retardant dispersible powder, made in accordance with Example 1 was added to an ABS composition, and tested for its effect on processing of the resulting ABS-containing composition. Typical compounding took place on a twin-screw extruder under varying conditions, as shown in Table 1.

Typical values for the process mixing torque and die pressure exerted during processing are shown in Table 2. Adding the solid flame-retardant dispersible powder reduced the mixing torque by approximately 12% and reduced die pressure by 0.2-0.3 MPa, similar to the reduction seen when castor wax is added to other antimony trioxide compositions. Absolute torque was comparable to that experienced at common loadings of AO5, while the die pressure exerted was 2-6% greater than that experienced using AO5. It is believed these effects are due to the lowering of the viscosity, as measured by capillary rheology, of the flame retardant-containing thermoplastic composition compared to unfilled ABS. Such a loss of viscosity may result in pseudoplastic behavior, where the rate of flow of the ABS composition, in relation to the shearing stress, increases at a higher than normal rate.

### Example 4

### Impact Properties of AT (Example 1)

The flame retardant dispersible powder, containing 85% by weight antimony trioxide and 15% by weight castor wax, made in accordance with Example 1, was added to an ABS composition and tested for its effect on impact properties, compared to several standards. In general, the addition of antimony trioxide-based particulate flame retardants had the effect of lowering the mean peak and main failure energies of the impact strength of the polymer composition, as defined by Charpy sample bars (see Table 3). The energies were measured on a Rosand Instrumented Falling Weight Impact Testing (IFWIT) 5 machine. The loss of the respective energies was proportional to the particle size of the additive. It can be clearly seen that the formulation containing 5% dispersible powder had a minimal effect on the impact properties of the polymer composition. Even at a flame-retardant loading of 11%, the impact loss was superior to that of much lower loadings of Red Star and approximately equal to that of AO5.

### Example 5

### AT (Example 1) Having Varying Ratios of AT/Core

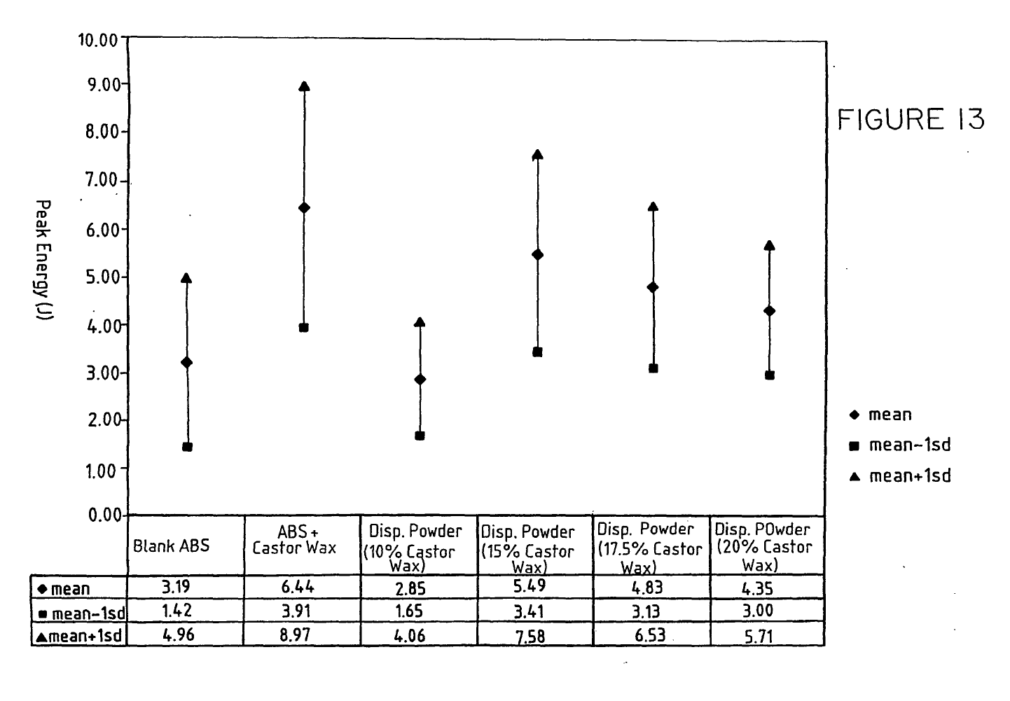

The flame retardant dispersible powder, containing varying levels of flame retardant relative to the wax carrier core material, made in accordance with Example 1, was added to an ABS composition and tested for their effects on impact properties. In all cases, the total level of flame retardant added was kept constant at 4% antimony trioxide by weight, based on the weight of the ABS polymer. Relative to unfilled ABS, the addition of the solid flame retardant generally increased both the peak force and peak energy measurement of the composition, as shown in FIGS. 12-13. It is believed, in the case where both the peak force and peak energy are lower than that of unfilled ABS, the weight ratio of antimony trioxide to castor wax is below the critical level for prill stability, causing flame retardant to separate from the wax prior to processing, generating flaws in the ABS polymer.

### Example 6

### 80% AT/20% Castor Wax Core

A dispersible powder containing 20% by weight castor wax and 80% by weight antimony trioxide was manufactured in accordance with Example 1, added to an ABS composition, and the flexural properties of the resultant ABS-flame retardant compositions were determined using a three point bend flexural test. Both the flexural modulus and flexural strength determination conform to American Society of Testing and Materials (ASTM) D790/BS2782 Part 3 Method A where:

E_{b}=(L³m)/(4bd³) and flexural strength σ_{b}=(3FL)/(2bd²)

where L is the support span, b is the sample width, F is the maximum load, d is the sample thickness, and m is the slope of the linear portion of the curve.

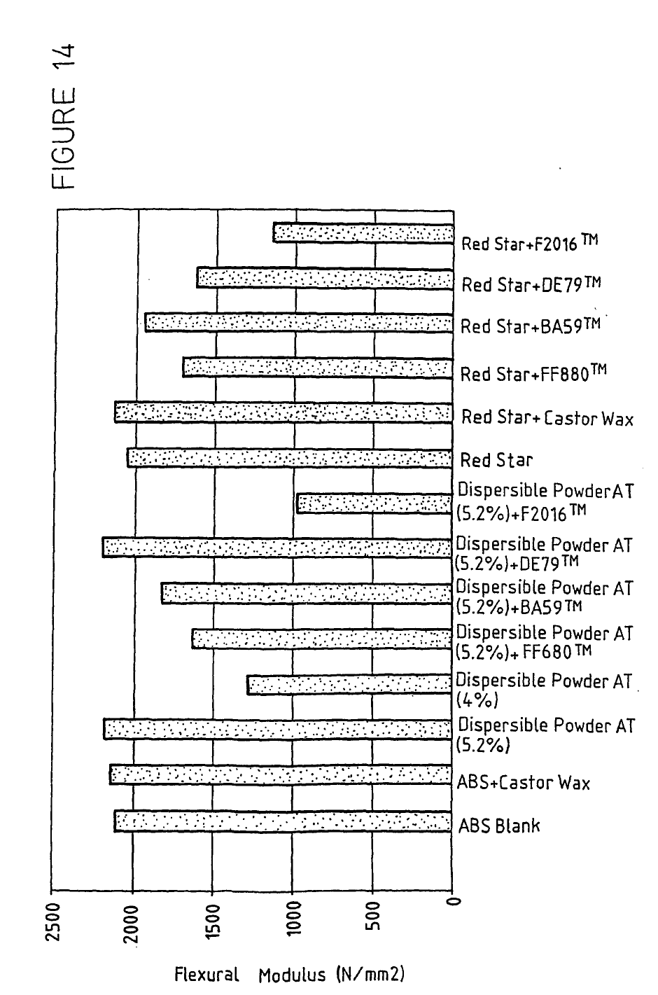

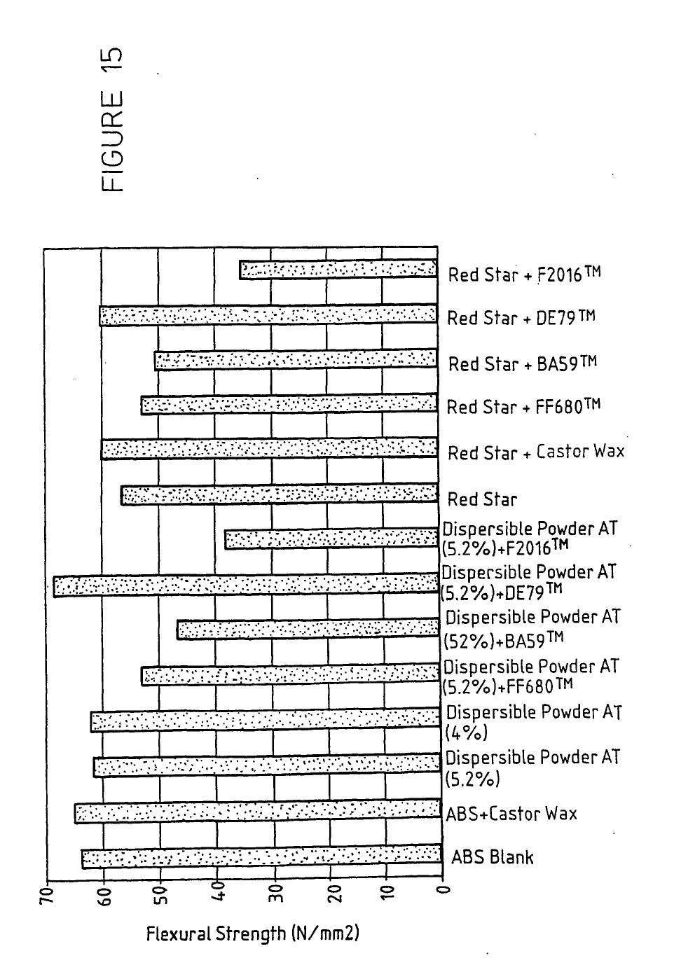

The results for flexural modulus tests are given in FIG. 14, and the results for the flexural strength tests are shown in FIG. 15. In general, the addition of the solid dispersion of the present invention to the ABS-containing composition increased flexural modulus by 1% relative to unfilled ABS, and decreased flexural strength by 2%. When ABS was filled with typical loadings of both AO5 and Red Star, the flexural modulus decreased by 12% and 13%, respectively, while flexural strength was unchanged for microfine AO5 and decreased by 7% for Red Star.

### Example 7

### Improved Fire Retardancy of ABS

Dispersible powders containing various percentages of antimony trioxide by weight, manufactured in accordance with Example 1, were added to ABS compositions of varying thicknesses and flame retardancy tested using the LOI (ASTM D 2863) and Underwriters Laboratories UL-94 standards. The results are shown in Tables 4 and 5. Addition of both wax alone and wax with solid flame retardant to ABS had no effect on the LOI, and resulted in either burning or high levels of flaming drops. When halogen compounds were added in conjunction with the solid flame retardant, LOI increased dramatically. At 1.6 mm thickness ABS, most formulations had a limited flame retardant effect by the UL-94 standard; addition of 20% by weight tetrabromobisphenol A (BA-59P of Great Lakes Chemical Corporation), a bromine compound, had a limited effect on the UL-94 rating of the ABS/flame retardant composition, but the LOI rating was comparable to that of other flame retardant compositions. Addition of octabromodiphenyl oxide (OBDPO, DE-79 of Great Lakes Chemical Corporation) and decabromodiphenyl oxide (DE-83R of Great Lakes Chemical Corporation) appeared to have little effect on the flame retardant compositions. At 3.2 mm thickness ABS, addition of the solid flame retardant in conjunction with halogen compounds allowed the ABS composition to receive the most stringent UL-94 rating.

TABLE 1
Typical Extruder Conditions
(Based On APV MP30TC Twin Screw Extruder)

| | Extruder temperature profile (° C.) | | | | | |
|---|---|---|---|---|---|---|
| | [die-feed zone] | | | | | Screw Speed |
| Die | Zone 2 | Zone 3 | Zone 4 | Zone 5 | Feed | (rpm) |
| 215 | 210 | 208 | 190 | 170 | 185 | 200 |

TABLE 2
Influence Of Dispersible Powder
And Wax On Compounding Variables

| | Compounder | Torque | Die Pressure |
|---|---|---|---|
| Compound | Speed (rpm) | (%) | (MPa) |
| ABS* | 200 | 76-80 | 2.87 |
| ABS* + 1 wt % | 200 | 72-76 | 2.80 |
| castor wax | | | |
| ABS* + 3 wt % | 200 | 62-68 | 2.72 |
| castor wax | | | |
| ABS* + dispersible | 200 | 64-66 | 2.55 |
| powder (3 wt % | | | |
| AT) | | | |
| ABS* + dispersible | 200 | 63-66 | 2.65 |
| powder (10 wt % | | | |
| AT) | | | |
| ABS* + 10 wt % | 200 | 67-69 | 2.51 |
| AO5 | | | |
| ABS* + 13 wt % | 200 | 50-60 | 2.34 |
| AO5 + castor wax | | | |

*Cycolac ™ T

TABLE 3
Peak And Failure Energies Of Charpy Notched Test Bars

| | Mean | Difference | Mean | Difference |
|---|---|---|---|---|
| | Peak | to blank | Failure | to blank |
| Formulation | Energy (J) | (%) | Energy (J) | (%) |
| ABS* blank | 0.51 | — | 1.17 | — |
| ABS* + 4 wt % | 0.22 | −43% | 0.80 | −32% |
| Red Star | | | | |
| ABS* + 4 wt % | 0.32 | −37% | 0.85 | −27% |
| Red Star + 1 | | | | |
| wt % castor wax | | | | |
| ABS* + 4 wt % | 0.41 | −19% | 0.99 | −15% |
| AO5 | | | | |
| ABS* + 4 wt % | 0.43 | −15% | 1.05 | −10% |
| AO5 + 1 wt % | | | | |
| castor wax | | | | |
| ABS* + 5 wt % | 0.51 | 0% | 1.20 | 0.02 |
| dispersible | | | | |
| powder | | | | |
| ABS* + 11 wt % | 0.41 | −17.9% | — | — |
| dispersible | | | | |
| powder | | | | |
| ABS* + 10 wt % | 0.37 | −25.5% | — | — |
| AO5 + 3 wt % | | | | |
| castor wax | | | | |

*Cycolac ™ T

TABLE 4
UL-94 And LOI Flame Test Results
Dispersible Powder Antimony Trioxide On 20% By Weight Castor Wax

| | | | Total | | | | |
|---|---|---|---|---|---|---|---|
| | | UL-94 | Burn | | UL-94 | Total Burn | |
| | LOI | (1.6 mm) | (secs) | Comments | (3.2 mm) | (secs) | Comments |
| ABS blank | 18.3 | Fail | | Burned to clamp | Fail | | Burned to |
| | | | | | | | clamp |
| ABS + castor wax (1%) | 17.6 | Fail | | Burned to clamp | Fail | | Burned to |
| | | | | | | | clamp |
| ABS + dispersible powder | 18.2 | Fail | | Burned to clamp | Fail | | Burned to |
| AT (5.2%) | | | | | | | clamp |
| ABS + dispersible powder | 18.4 | Fail | | Burned to clamp | Fail | | Burned to |
| AT (4%) | | | | | | | clamp |
| ABS + dispersible powder | 24.2 | V-2 | 81 | Flaming drips | V-0 | 4 | |
| AT (5%) + FF680 ™* | | | | | | | |
| (18%) | | | | | | | |
| ABS + dispersible powder | 27.6 | V-2 | 39 | Flaming drips | V-0 | 5 | |
| AT (5%) + BA-59P ™** (18%) | | | | | | | |
| ABS + dispersible powder | 28.8 | V-2 | 6 | Flaming drips | V-0 | 5 | |
| AT (5%) + DE-79*** (18%) | | | | | | | |
| ABS + dispersible powder | 30.2 | V-2 | 21 | Flaming drips | V-0 | 4 | |
| AT (5%) + F-2016 ™**** (18%) | | | | | | | |
| ABS + 6 phr dispersible powder | 26.6 | V-0 | | | | | |
| AT + 18 phr DE-79 ™*** | | | | | | | |
| ABS + dispersible powder | 26.5 | V-0 | | | | | |
| AT (5.7%) + FF-680 ™*** (18%) | | | | | | | |
| ABS + dispersible powder | 27.5 | V-2 | | | | | |
| AT (5.7%) + BA-59P ™ (20%) | | | | | | | |
| ABS + dispersible powder AT | 29.5 | V-0 | | | | | |
| (5.7%) + dispersible powder | | | | | | | |
| DE-83R ™ (20%) | | | | | | | |
| ABS + Red Star (5%) | 19 | Fail | | Burned to clamp | Fail | | Burned to |
| | | | | | | | clamp |
| ABS + Red Star (5%) + | 18.2 | Fail | | Burned to clamp | Fail | | Burned to |
| castor wax (1%) | | | | | | | clamp |
| ABS + Red Star (5%) + | 25.4 | V-2 | 11 | Flaming drips | V-0 | 10 | |
| FF-680 ™ (20%) | | | | | | | |
| ABS Red Star (5%) + | 25.3 | V-2 | 28 | Flaming drips | V-0 | 5 | |
| BA-59P ™ (20%) | | | | | | | |
| ABS + Red Star (5%) + | 28.7 | V-2 | 7 | Flaming drips | V-0 | 22 | |
| DE-79 ™ (20%) | | | | | | | |
| ABS + Red Star (5%) + | 29 | V-0 | 4 | Drips, no ignition | V-0 | 0 | |
| F-2016 ™ (20%) | | | | | | | |
| ABS + 6 phr Red Star + | 26.1 | Fail | | | | | |
| 20 phr DE-79 ™ | | | | | | | |

*bis(tribromophenoxy)ethane
**tetrabromobisphenol A
***octabromodiphenyl oxide
****brominated epoxy oligomer

TABLE 5
UL-94 And LOI Flame Testing Data
Dispersible Powder AT On 13% By Weight Castor Wax

| | | UL-94 | Total Burn |
|---|---|---|---|
| | LOI | (1.6 mm) | (secs) |
| ABS blank | 18.3 | Fail | |
| ABS + castor wax (0.7%) | 17.6 | Fail | |
| Dispersible powder AT (5.2%) | 18.2 | Fail | |
| Dispersible powder AT (4%) | 18.4 | Fail | |
| Dispersible powder AT + | 24.2 | V-2 | 8 |
| FF-680 ™ (18%) | | | |
| Dispersible powder AT + | 27.6 | V-0 | 5 |
| BA-59P ™ (20%) | | | |
| Dispersible powder AT + | 28.8 | V-0 | 4 |
| DE-79 ™ (18%) | | | |
| Dispersible powder + F-2016 ™ | 30.2 | V-0 | 5 |
| (18%) | | | |

### Example 8

### Higher Percentage of Hexadecylpyridinium Chloride

Decabromodiphenyloxide (DE-83R) on a Castor Wax Core in ABS Polymer

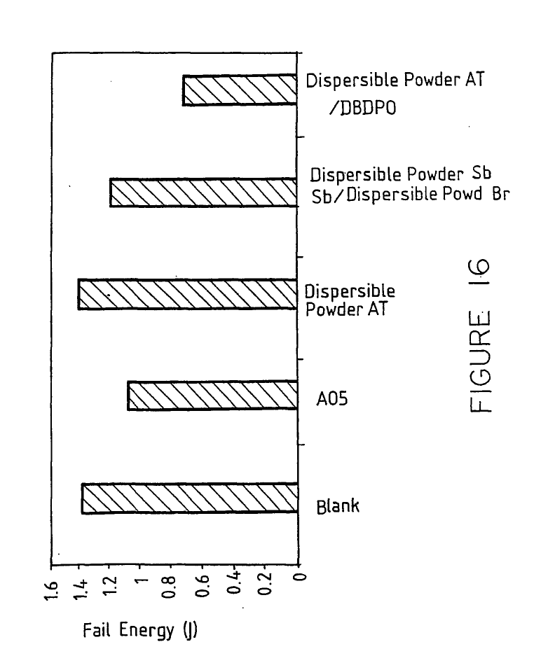

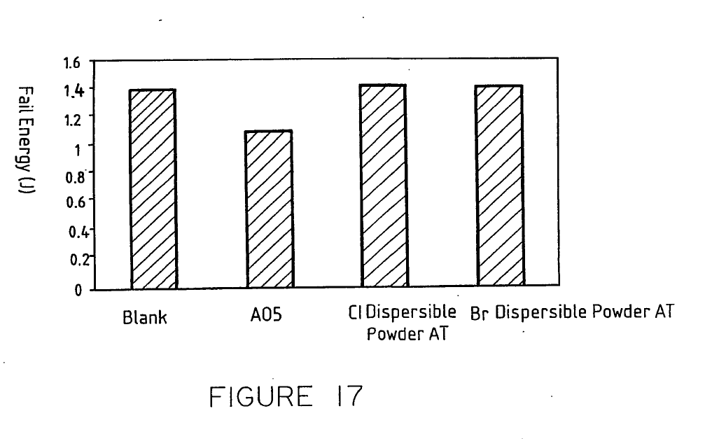

The flame retardant dispersible powder was made in accordance with Example 1, except hat a slightly higher concentration of hexadecylpyridinium chloride was used (7.5×10⁻³ M/L) and the DE-83R coating layer had a thickness of 0.2 μm instead of 0.1 μm. The size distribution of the dried prills was 10-40 μm, the DE-83R layer thickness being 5-20 μm (there is a thicker layer due to a lower packing density associated with the larger particle size used). The component manufactured was tested along with various ABS controls, a AO5 control, a 0.1 μm antimony Azub™ control with and without unmilled DEDPO, and finally a compound with milled antimony and milled DBDPO (LOI and UL-94 results previously given in Table 4). Mechanical and fire testing is summarized in Table 6, and in FIG. 16:

TABLE 6

| | | | | Dispersible | |
|---|---|---|---|---|---|
| | | | Dispersible | Powder AT* | Dispersible |
| | | | Powder | (5%) | Powder AT* |
| | | AO5 | AT* | Dispersible Powder | (5%) |
| ABS+ | Blank | (4%) | (5%) | DE-83R (15%) | DE-83R (12%) |
| Fail Energy (J) | 1.40 | 1.10 | 1.42 | 1.21 | 0.74 |
| (s.d.) | (0.10) | (0.08) | (0.08) | (0.10) | (0.18) |
| LOI | 18.3 | 18.9 | 18.4 | 29.5 | 26.8 |
| UL-94** | Fail | Fail | Fail | V-0 | V-2 |

*dispersible powder AT contains 20% wax, 4 wt % Sb and 12 wt % DE-83R
**at 1.6 mm thickness

The graphical representation of the fail energy (FIG. 16) illustrates the benefits to mechanical properties of the smaller particle size and subsequent phase transfer of the powdered DE-83R (original particle size of 6 μm) onto a core carrier.

### Example 9

### Hexadecylpyridinium Bromide

The flame retardant dispersible powder was made in the same manner described in Example 1, except that hexadecylpyridinium bromide was used as the emulsifier instead of hexadecylpyridinium chloride. This results in an identical product, in size, and the like, to the product of Example 1. There are slight differences in the melting point of the bromide version of the emulsifier, but this is irrelevant. Table 7, below, summarizes the comparison of mechanical and fire properties between the bromide and chloride version of the hexadecylpyridinium salts:

TABLE 7

| | | | Dispersible | Dispersible |
|---|---|---|---|---|
| | | | powder AT* | powder AT* |
| | | | (5%) | (5%) |
| ABS+ | Blank | AO5 | Cl ion | Br ion |
| Fail Energy | 1.40 | 1.10 | 1.42 | 1.41 |
| (J) | | | | |
| standard deviation | (0.10) | (0.08) | (0.08) | (0.12) |

*dispersible powder AT contains 20% wax, 4 wt % Sb and 12 wt % DE-83R

No UL-94 or LOI tests were carried out since there were no bromine compounds present in the resulting flame-retarded ABS composition. Only a comparison between Br and Cl⁻ variations of the emulsifying agents tested for mechanical properties. The carryover of the salt to the final product is minimal and would not effect flame retardant properties (carryover probably of the level compounds is best shown graphically, to be essentially identical, as shown in FIG. 17.

### Example 10

### AT on an Amide Wax Core

The flame retardant dispersible powder was made in the same manner described in Example 1, except that an amide wax (melting point 160° C.) was used instead of castor wax. The wax used was Hoechst Wax C. The amide wax is a low molecular weight polymer. The wax is supplied in a fine form (5-10 μm) giving an increased surface area over less finely divided forms. The resulting dispersible powder AT flame retardant powder was manufactured having 10 wt % wax and 90 wt % AT via the following procedure:

Hexadecylpyridinium chloride was added to water at a temperature of greater than 83° C. at an approximate concentration of 7.5×10⁻³ M/L. The solution was then mechanically agitated. To this agitated solution the finely divided wax powder was slowly added, forming a dispersion of the wax particles in water. The dispersion was wetted and consequently stabilized by the adhesion of the hexadecylpyridinium ion to the surface of the wax particle, as shown schematically in FIG. 2. The hydrophobic tails of the ions pack tightly around the outer surface of the wax core, leaving a hydrophilic, positively charged, dispersant layer around each core particle (the positively charged layer stops the particles from forming flocs or agglomerates in solution).

Once the amide wax material was completely dispersed, as in Example 1, the antimony trioxide slurry was followed by the layering mechanism, settling, decanting and drying, as in accordance with Example 1.

The procedure produces a very fine, dispersible powder product with a size of 10-20 μm with a calculated antimony trioxide layer thickness of 5-10 μm.

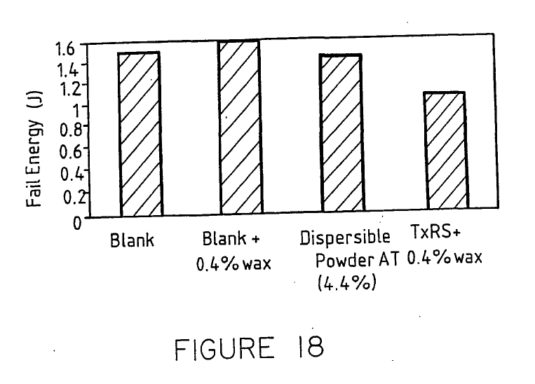

This material was compounded into a standard unfilled injection molding grade of Nylon 6,6 (DuPont Zytel 101F) and impact strength tested as a measure of physical performance and impact strength tested as a measure of physical performance. Table 8 below, and FIG. 18, summarizes the testing results.

TABLE 8

| | | | Dispersible | Read Star |
|---|---|---|---|---|
| | | Blank + 0.4% | powder AT | (4%) + |
| | Blank | Wax C | (4.4%)** | 0.4% Wax C |
| Fail Energy | 1.52 | 1.60 | 1.44 | 1.09 |
| (J) | | | | |
| standard deviation | (0.20) | (0.21) | (0.26) | (0.34) |

*Compared to ABS, the nylon used is very much more brittle, which results from its more crystalline nature. There are no inclusions in the nylon polymer matrix (as in polybutadiene spheres within the ABS matrix) so the test method is much more severe on this polymer. Normally a glass filled (reinforced) nylon would be used for high impact scenarios, so this test only serves to show improvement in properties using dispersible powders AT when compared to Red Star.
**4% AT on 0.4% amide wax core (Wax C).

Again, as shown graphically in FIG. 18, there is a very large distinction between dispersible powder AT material and the standard grade of Red Star. The Red Star in the trials also had 0.4% wax added to allow for the plasticizing and lubricating effect of the wax in all samples.

The dispersible powder AT material added at 4.4 wt % (4% AT and 0.4% Wax C) has retained 94.7% of the strength of the blank compared to only 71.7% retained by the standard grade (Red Star).

### Example 11

### Flame Retardant Dispersible Powder in Thermoplastic Fibers

Currently, the incorporation of solid particulate flame retardants into thermoplastic fiber compounds causes severe processing problems when spinning and weaving the fibers. To produce thermoplastic fibers (usually PET, polyamide (nylon) or PP) a melt is produced (usually in a single screw extruder) and is metered (pumped) through a filter pack and then a set of spinnerettes (dies). For the production of fibers during this testing, a lab scale fiber line was used. This fiber line has a 120 hole 0.52 mm trilobal filament spinnerette. After material has been passed through the spinerettes, it is passed around a series of rollers. The first set of rollers are matched in rotational speed to the speed of extrusion of the machine, the second set reheats the filaments (to approximately 60-70° C.), and the third set rotate at an increased rpm. This increase in rpm causes the fibers to draw. Typically a draw ratio of 1:4 is used. This reduces the cross sectional size of the fiber.

If there are any large particles within the fiber, fibers have a tendency to break on drawing. Also, any particles near the surface of the fiber cause the fiber to have a relatively abrasive surface, thus wearing any thread guides used during later processes. The process and materials of the present invention should eliminate these problems.

A dispersible powder AT was produced using antimony trioxide and an ester wax (Hoechst Wax E). The Wax E has a melting point of 82° C., so the initial processing was carried out above this temperature and in accordance with Example 1. The resultant powder was similar in all characteristics to the product of Example 1. The material had 18 wt % wax and 82 wt % antimony trioxide.

This powder was processed on a twin screw extruder into an unfilled natural color polypropylene polymer (Targor Novalen 1100N). The material was compounded as a dispersible powder AT—only compound, as well as with a brominated component GPP-39 (Great Lakes Chemical Corporation), which is a melt-blendable brominated graft copolymer of polypropylene and dibromostyrene.

Following extrusion and granulation, the compounds were passed through the fiber line. The materials were tested for strength using an Instron tensile testing apparatus. The apparatus measured the applied load on fibers against the applied displacement. Two measurements were observed. The initial yield of the fiber and the maximum load of the fiber, as shown in Table 9.

TABLE 9

| | | | | Dispersible | |
|---|---|---|---|---|---|
| | | | | Powder AT | |
| | | Dispersible | GPP-39 | (2.5%) + | AO5(2%) + |
| | | Powder AT | Only | GPP-39 | GPP-39 |
| PP+ | Blank | Only (2.5%) | (15.4%) | (15.4%) | (15.4%) |
| Maximum | 69.12 | 66.31 | 49.43 | 44.17 | 25.28 |
| Load (N) | | | | | |
| Initial | 46.5 | 45.2 | 47.2 | 48.4 | 26.5 |
| Yield (N) | | | | | |

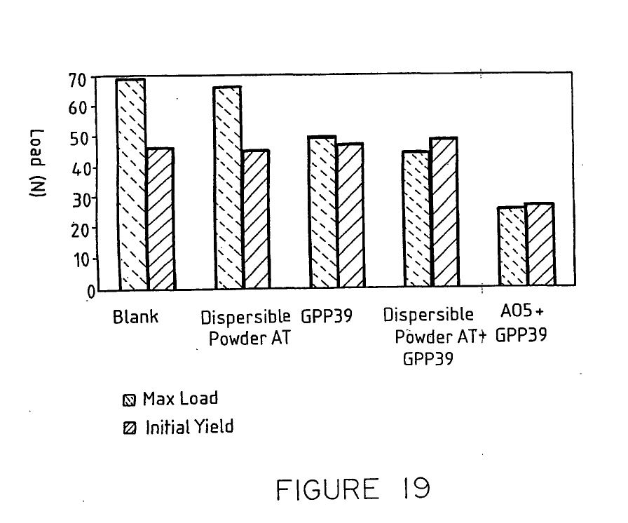

The data of Table 9 are shown graphically in FIG. 19.

There is only a 4% loss in maximum load from blank to dispersible powder AT-only compound, compared to 63% loss for the AO5 compound. The initial yield of the compound increases as the GPP-39 compound is added, with the highest result of all being the Azub™+GPP-39. This increase in initial yield is probably due to a combination of the Wax E acting as a plasticizer, and the positioning of the GPP-39 in the fiber lattice allowing ore initial elongation before the polymer molecules within the fiber begin to straighten.

Some basic fire testing was carried out on plaited sections of fibers. The basic test involved igniting a suspended fiber for 2×10 seconds with a 1 inch bunsen burner flame and observing the flame behavior (this is similar to the UL-94 test). These results are summarized in Table 10:

TABLE 10

| | | Dispersible | | Dispersible | |
|---|---|---|---|---|---|
| | | Powder AT | GPP-39 | Powder AT | AO5 (2%) + |
| | | Only | Only | (2.5%) + | GPP-39 |
| PP+ | Blank | (2.5%) | (15.4%) | GPP-39 (15.4%) | (15.4%) |
| Flammability | Ignited, | Ignited, | Ignited, | extinguished | Flame |
| Characteristics | burning | burning | burning | after both | extinguished |
| | drips | drips | drips | flame | through fire |
| | | | | applications, | dripping away |
| | | | | no dripping | from the fiber |

### Example 12

A flame retardant dispersible powder was made in the same manner as described in Example 1, except that sodium antimonate was used as the flame retardant material and Abril Abriflow 85 powder (Industrial Waxes Limited), an amide based wax, was used as the core material, using the conditions and amounts of Example 1. This material was formulated into PET fibers (Kodapak PET 7352), successfully.

What is claimed is:

1. A process for manufacturing a flame retardant dispersible powder secured to an outer surface of a core material comprising:
forming an emulsion of liquid particles, or a dispersion of solid particles, of a core material and a carrier fluid containing a first surfactant to impart an electrostatic charge to the emulsified particles of said core material;
processing a solid flame retardant to an individual primary particle size of 1 micron or less, and combining the flame retardant with a second surfactant in a liquid carrier, said second surfactant imparting an electrostatic charge to said flame retardant particles such that when the charged flame retardant particles are combined with the charged core material particles, the flame retardant particles will electrostatically adhere or complex to an outer surface of the core material particles;
combining the flame retardant particles with the core material particles; and
separating the carrier fluid from the flame retardant particles and underlying core material.

2. The process of claim 1 further including the step of drying the flame retardant particles surrounding the core material.

3. The process of claim 1, wherein the flame retardant particles comprise antimony trioxide.

4. The process of claim 1, wherein the core material is a wax.

5. The process of claim 4, wherein the wax is a hydrogenated castor oil.

6. The process of claim 1, wherein the core material is a polymer.

7. The process of claim 1, wherein the core material is an organic liquid.

8. The process of claim 1, wherein the core material is an organic solid.

9. The process of claim 1, wherein the amount of core material is in the range of about 2% to about 50% by weight, based on the dry weight of the flame retardant particles.

10. The process of claim 9, wherein the amount of core material used is in the range of about 10% to about 15% by weight, based on the dry weight of the flame retardant particles.

11. The process of claim 1, wherein the first surfactant possesses an electric charge.

12. The process of claim 11, wherein the first surfactant is a pyridinium salt.

13. The process of claim 12, wherein the first surfactant is a halogenated pyridinium salt having a carbon chain length of C₁₂-C₁₈.

14. The process of claim 13, wherein the first surfactant is selected from the group consisting of dodecylpyridinium bromide; dodecylpyridinium chloride; dodecylpyridinium iodide; butadecylpyridinium bromide; butadecylpyridinium chloride; hexadecylpyridinium bromide; hexadecylpyridinium chloride; octadecylpyridinium bromide; and octadecylpyridinium chloride; and a mixture of any two or more thereof.

15. The process of claim 14, wherein the first surfactant is hexadecylpyridinium chloride monohydrate.

16. The process of claim 11, wherein the second surfactant possesses an electric charge opposite to that of the first surfactant, and said first and second surfactants are combined with the flame retardant particles and the core material particles before separating flame retardant-coated particles from the carrier fluid.

17. The process of claim 16, wherein the second surfactant is selected from the group consisting of a lignosulfate, phosphate ester, sulfated alcohol ethoxylate, alkylbenzenesulfonate, sulfonate ester, naphthalene sulfonate, α-olefinsulfonate, sodium silicate, N-acylsarcosinate, polyacrylate, polycarboxylic acid salt, polymaleic anhydride/polyethylene glycol (PMA/PEG) blend, amine, amine oxide, amine ethoxylate, quaternary ammonium salt, alkyl betaine, imidazoline, and mixtures thereof.

18. The process of claim 17, wherein the second surfactant is Borresperse Na.

19. The process of claim 1, wherein the flame retardant is electrostatically bound to the surface of the core material such that the radius of the flame retardant particles, measured outwardly from the surface of the core material is in the range of about 0.3 microns to 50 microns.

20. The process of claim 19, wherein the radius of the flame retardant particles, measured outwardly from the surface of the core material is in the range of about 1 micron to about 50 microns.

21. The process of claim 20, wherein the radius of the flame retardant particles, measured outwardly from the surface of the core material is in the range of about 1 micron to about 10 microns.

22. The process of claim 21, wherein the radius of the flame retardant particles, measured outwardly from the surface of the core material, is in the range of about 5 microns to about 10 microns.

23. A process for securing a flame retardant dispersible powder onto the surface of a core material to prevent agglomeration of finely divided flame retardant particles, comprising:
forming an emulsion of a carrier liquid and a first surfactant with a core material selected from the group consisting of a wax, a polymer, an organic liquid, and an organic solid;
processing a solid flame retardant to form the flame retardant in dispersible powder form, and emulsifying the flame retardant dispersible powder with a second surfactant;
combining the flame retardant dispersible powder with the emulsified core material in a liquid emulsion to deposit the flame retardant powder onto outer surfaces of the emulsified core material;
separating the liquid emulsion from the flame retardant powder-coated core material; and
drying the flame retardant powder-coated core material.
